(19) United States
(12) Patent Application Publication
(10) Pub. No.: US 2026/0116785 A1
(43) Pub. Date: Apr. 30, 2026

(54) WASTEWATER ZERO DISCHARGE MONITORING METHOD AND SYSTEM

(71) Applicant: DATANG ENVIRONMENT INDUSTRY GROUP CO., LTD., Beijing (CN)

(72) Inventors: Li FEI, Beijing (CN); Bai YUYONG, Beijing (CN); Liang XIUGUANG, Beijing (CN); Meng LEI, Beijing (CN); Zhu LIMING, Beijing (CN); Zhang GUOZHU, Beijing (CN); Yang YAN, Beijing (CN); Peng SIWEI, Beijing (CN); Gao YANG, Beijing (CN); Meng YUERAN, Beijing (CN)

(73) Assignee: DATANG ENVIRONMENT INDUSTRY GROUP CO., LTD., Beijing (CN)

(21) Appl. No.: 18/874,031

(22) PCT Filed: Nov. 1, 2024
(86) PCT No.: PCT/CN2024/129377

§ 371 Date: Dec. 11, 2024

(30) Foreign Application Priority Data
Oct. 25, 2024 (CN) 202411496189.8

(51) Int. Cl. C02F 1/04; C02F 1/12; C02F 103/34

(52) U.S. Cl. CPC C02F 1/048; C02F 1/12; C02F 2103/34; C02F 2209/001; C02F 2209/02; C02F 2209/10; C02F 2209/38; C02F 2209/40; C02F 2209/44

(57) ABSTRACT

The present application provides a monitoring method and a monitoring system for wastewater zero discharge. The monitoring method includes steps of S1: feeding atomized wastewater into a drying tower, extracting high temperature flue gas into the drying tower to evaporate the atomized wastewater droplets, and monitoring an outlet flue gas temperature T₂ of the drying tower in real time; S2: obtaining a movement time t₁ of the flue gas in a constant rate evaporation stage and a movement time t₂ of the flue gas in a falling rate evaporation stage, respectively, and obtaining a total residence time tₐₗₗ of the flue gas according to the movement time t₁ and the movement time t₂, tₐₗₗ=t₁+t₂; and S3: adjusting flow rates of the wastewater and the flue gas according to the total residence time tₐₗₗ of the flue gas, and maintaining the outlet flue gas temperature T₂ of the drying tower within the range of 428 K to 448 K. In this application, the relationship between flue gas velocity and temperature is taken into full consideration. The operation stability of the drying tower is remarkably improved, and the effect for drying wastewater is ensured.

### FIELD OF THE INVENTION

The invention relates to the technical field of wastewater treatment, and in particular to a monitoring method and a system for wastewater zero discharge.

### BACKGROUND OF THE INVENTION

High-salinity wastewater (such as chemical regeneration wastewater, wet desulfurization wastewater and the like) discharged from a thermal power plant has a complex composition. Discharging it directly into the environment can lead to significant pollution. At present, spray drying technology is one of the mainstream technologies for realizing zero discharge of the high-salinity wastewater in the electricity industry. The technology incorporates a rotary atomizer that disperses the wastewater into fine droplets, which are then sprayed into a drying tower. Concurrently, high-temperature flue gas from the thermal power plant is extracted into the drying tower. Within the tower, the flue gas undergoes an intensive heat exchange with the wastewater droplets, rapidly facilitating the evaporation process and achieving zero liquid discharge of the wastewater.

Residence time of the high temperature flue gas within the drying tower determines heat exchange time of gas-liquid two-phase fluid, and is also a key parameter influencing the effect of zero discharge of wastewater. At this stage, the calculation method for the residence time is relatively rudimentary. Generally, the average flow rate of flue gas within the drying tower is determined by taking the mean of the inlet and outlet flue gas temperatures. Following this, the residence time of the flue gas is ascertained by the height of the drying tower.

However, since the drying process of wastewater within the drying tower includes constant-rate evaporation and falling-rate evaporation stages, the temperature of the flue gas will continuously decrease as it flows from top to bottom, with varying degrees of temperature drop, which in turn causes changes in its flow velocity. The existing calculation method for residence time cannot reflect the flow velocity changes with temperature. Estimating the flue gas residence time using the method of average temperature and average flow velocity can lead to unreasonable operation and control of the zero liquid discharge system, causing insufficient system output or poor zero liquid discharge effects, and thus severely affecting the stable operation of the system.

In addition, physical property parameters of the high temperature flue gas from the thermal power plant exhibit a certain degree of variability. Since these parameters are unstable and cannot be controlled, using the flue gas for the evaporative drying of wastewater can lead to unstable evaporation effects and failures, such as wet ash, blockages, and corrosion caused by poor evaporation. These issues can severely and adversely affect the operation of the drying tower.

In order to ensure zero discharge of the wastewater, it is necessary to calculate the residence time of the flue gas in a more rational way and make necessary adjustments to the system operation parameters according to the residence time.

In view of this, the present application is specifically proposed.

### SUMMARY OF THE INVENTION

The purpose of the present application is to provide a monitoring method and a monitoring system for wastewater zero discharge. The variation of flue gas velocity within a drying tower in response to temperature changes is taken into full consideration. Thereby, the operation stability of the drying tower is enhanced remarkably, and the effect of drying wastewater is ensured.

The present application provides a monitoring method for wastewater zero discharge including steps of:
S1: feeding atomized wastewater into a drying tower, extracting high temperature flue gas into the drying tower to evaporate the atomized wastewater droplets, and monitoring an outlet flue gas temperature T₂ of the drying tower in real time;
S2: obtaining a movement time t₁ of the flue gas in a constant rate evaporation stage and a movement time t₂ of the flue gas in a falling rate evaporation stage, respectively, and obtaining a total residence time tₐₗₗ of the flue gas according to the movement time t₁ and the movement time t₂, tₐₗₗ=t₁+t₂; and
S3: adjusting flow rates of the wastewater and the flue gas according to the total residence time tₐₗₗ of the flue gas, and maintaining the outlet flue gas temperature T₂ of the drying tower within the range of 428 K to 448 K.

In step S1, the upper part of the drying tower is a hollow cylinder, which is the main area for wastewater evaporation. The bottom of the drying tower is a hollow cone, which is mainly used for ash deposition. Unless otherwise specified, the drying tower refers to the section of the hollow cylinder. A rotary atomizer is installed on the top of the drying tower to atomize the wastewater. Rotation speed of the rotary atomizer is controlled between 12000 r/min-18000 r/min, and the wastewater droplets formed by atomization have the diameter of 10 μm-60 μm.

In step S2, evaporation process of the wastewater droplets inside the drying tower includes constant rate evaporation and falling rate evaporation stages. Herein, the constant rate evaporation takes place in the upper part of the drying tower, where the moisture on the surface of the wastewater droplets rapidly exchanges heat with the high-temperature flue gas, causing a sharp decrease in flue gas temperature and rapid evaporation of the wastewater. Dissolved salts and suspensions in the wastewater form solid shells, which slow down the rate of moisture evaporation. The falling rate evaporation takes place in the lower part of the drying tower. Affected by the solid shells formed, the wastewater evaporation rate and flue gas temperature drop get slower.

After the flue gas enters the drying tower, its vertical flow velocity can be calculated by the following formula:

$$v = \frac{V}{S} = \frac{nR}{PS} T ,$$

where v is the vertical flow velocity of the flue gas; V is the volume flow of the flue gas (referred to as flue gas flow); n is the molar flow rate, calculated from the volume flow of the flue gas; R is the gas constant; Tis the Kelvin temperature of the flue gas; P is the pressure of the flue gas; and S is the cross-sectional area of the drying tower, calculated from the diameter of the drying tower.

An intermediate thermometer is installed on the drying tower, and is installed between the constant rate evaporation stage and the falling rate evaporation stage. The intermediate thermometer is used for detecting the critical temperature of the flue gas between the constant rate evaporation stage and the falling rate evaporation stage.

From the top of the drying tower to the location of the intermediate thermometer is the constant rate evaporation stage of the wastewater. Within this distance, the temperature of the flue gas decreases sharply as it moves downward. The relationship between the flue gas temperature and the vertical movement distance is simulated by the following linear model:

$$T = {a}_{1} L + {b}_{1} ,$$

where L is the flue gas vertical movement distance (starting from the top of the drying tower), and a₁ and b₁ are model parameters.

It is assumed that T_{c} is the critical temperature between the constant rate evaporation stage and the falling rate evaporation stage, T₁ is the inlet flue gas temperature, and L₁ is the distance between the intermediate thermometer and the top of the drying tower (that is, the vertical flow distance of the flue gas in the constant rate evaporation stage, and is about 2.5 m-5.4 m).

When L=0, T=T₁. When L=L₁, T=T_{c}. Therefore, a₁ and b₁ are obtained by the following formulas:

$${a}_{1} = \frac{{T}_{c} - {T}_{1}}{{L}_{1}} , {b}_{1} = {T}_{1} ,$$

where T_{c} is the critical temperature of the flue gas between the constant rate evaporation stage and the falling rate evaporation stage, T₁ is the inlet flue gas temperature, and L₁ is the vertical flow distance of the flue gas in the constant rate evaporation stage.

Since the vertical flow velocity of the flue gas is the derivative of the vertical movement distance with respect to the movement time, that is,

$$\frac{{d}_{L}}{{d}_{t}} = v = \frac{nR}{PS} ( {a}_{1} L + {b}_{1} ) ,$$

the flue gas movement time t (starting from the top of the drying tower) is calculated by the following formula:

$$t = \int \frac{PS}{{nRa}_{1} L + {nRb}_{1}} {d}_{L} .$$

When L=0, t=0, and it is obtained as follows:

$$t = \frac{PS}{{nRa}_{1}} Ln ( \frac{{a}_{1}}{{b}_{1}} L + 1 ) .$$

In the constant rate evaporation stage, let L=L₁, and the movement time of the flue gas in the constant rate evaporation stage can be calculated, denoted as t₁.

That is, the movement time t₁ of the flue gas is obtained by the following formula:

$${t}_{1} = \frac{PS}{{nRa}_{1}} Ln ( \frac{{a}_{1}}{{b}_{1}} {L}_{1} + 1 ) ,$$

where t₁ is the movement time of the flue gas in the constant rate evaporation stage; P is the pressure of the flue gas; S is the cross-sectional area of the drying tower; n is the molar flow rate; R is the gas constant; a₁ and b₁ are model parameters; and L₁ is the vertical flow distance of the flue gas in the constant rate evaporation stage.

From the intermediate thermometer to the bottom outlet flue of the drying tower is the falling rate evaporation stage. Within this distance, the flue gas temperature decreases slowly as it moves downward. The relationship between the flue gas temperature and the vertical movement distance is simulated by the following linear model:

$$T = {a}_{2} L + {b}_{2} ,$$

where L is the vertical movement distance of the flue gas (with the start of the falling rate evaporation stage, denoted as L₂), and a₂ and b₂ are model parameters.

It is assumed that T₂ is the outlet flue gas temperature, and h is the height of the drying tower. When L=0, T=T_{c}. When L=h−L₁, T=T₂. Therefore, a₂ and b₂ are obtained by the following formulas:

$${a}_{2} = \frac{{T}_{2} - {T}_{c}}{h - {L}_{1}} ,$$

$${b}_{2} = {T}_{c} ,$$

where T₂ is the outlet flue gas temperature; T_{c} is the critical temperature of the flue gas between the constant rate evaporation stage and the falling rate evaporation stage; h is the height of the hollow cylinder of the drying tower, and L₁ is the vertical flow distance of the flue gas in the constant rate evaporation stage.

The vertical flow velocity of the flue gas is the derivative of the vertical movement distance with respect to the movement time, that is:

$$\frac{{d}_{L}}{{d}_{t}} = v = \frac{nR}{PS} ( {a}_{2} L + {b}_{2} ) .$$

The movement time t of the flue gas is calculated by the following formula (with the start of the falling rate evaporation stage, denoted as t₂):

$$t = \int \frac{PS}{{nRa}_{2} L + {nRb}_{2}} {d}_{L} .$$

When L=0, t=0, and it is obtained as follows:

$$t = \frac{PS}{{nRa}_{2}} Ln ( \frac{{a}_{2}}{{b}_{2}} L + 1 ) .$$

In the falling rate evaporation stage, let L=h−L₁=L₂, and the movement time of the flue gas in the falling rate evaporation stage can be calculated, denoted as t₂.

That is, the movement time t₂ of the flue gas is obtained by the following formula:

$${t}_{2} = \frac{PS}{{nRa}_{2}} Ln ( \frac{{a}_{2}}{{b}_{2}} {L}_{2} + 1 ) ,$$

where t₂ is the movement time of the flue gas in the falling rate evaporation stage; P is the pressure of the flue gas; S is the cross-sectional area of the drying tower; n is the molar flow rate; R is the gas constant; a₂ and b₂ are model parameters; and L₂ is the vertical flow distance of the flue gas in the falling rate evaporation stage.

According to the solid content x of the wastewater, the control range for the total residence time tₐₗₗ (calculated as step S2) of the flue gas is determined as follows.

When the solid content x of the wastewater is: x≤10%, the control range for the total residence time tₐₗₗ is [30 s, 35 s), that is, 30 s≤tₐₗₗ<35 s.

When the solid content x of the wastewater is: 10%<x≤20%, the control range for the total residence time tₐₗₗ is [35 s, 40 s), that is, 35 s≤tₐₗₗ<40 s.

When the solid content x of the wastewater is: 20%<x≤30%, the control range for the total residence time tₐₗₗ is [40 s, 45 s], that is, 40 s≤tₐₗₗ≤45 s.

In addition, the wastewater flow rate and the flue gas flow rate are adjusted as follows.

When the total residence time tₐₗₗ of the flue gas is within the control range and the outlet flue gas temperature T₂ of the drying tower is maintained at 428 K-448 K, keep the wastewater flow rate and the flue gas flow rate unchanged.

When the total residence time tₐₗₗ of the flue gas is below the lower limit of the control range, reduce the wastewater flow rate and the flue gas flow rate until the total residence time tₐₗₗ is within the control range, and the outlet flue gas temperature T₂ of the drying tower is maintained at 428 K-448 K. During the adjusting process, the decreasing rate of the flue gas flow rate should not exceed that of the wastewater flow rate.

When the total residence time tₐₗₗ of the flue gas is higher than the upper limit of the control range, increase the wastewater flow rate and the flue gas flow rate until the total residence time tₐₗₗ of the flue gas is within the control range, and the outlet flue gas temperature 72 of the drying tower is maintained at 428 K-448 K. During the adjusting process, the increasing rate of the wastewater flow rate should not exceed that of the flue gas flow rate.

In the present application, the relationship between flue gas velocity and temperature is taken into full consideration, and the total residence time tₐₗₗ of the flue gas can be accurately obtained. Meanwhile, the flow rates of wastewater and flue gas are cooperatively adjusted according to the control range of the total residence time tₐₗₗ. This effectively overcomes issues such as the instability of high-temperature flue gas entering the drying tower, and avoids unstable evaporation effects and faults such as wet ash, blockages, and corrosion that can occur during the operation of the drying tower. The operation stability of the drying tower is ensured.

The present application further provides a monitoring system for wastewater zero discharge for implementing the monitoring method mentioned above. The monitoring system for wastewater zero discharge includes a drying tower and a controller. A rotary atomizer is installed on the top of the drying tower and is connected with a wastewater pipeline, and a wastewater adjusting valve is installed on the wastewater pipeline. An inlet flue and an outlet flue are installed on the top and bottom of the drying tower, respectively. A flue gas adjusting valve, an inlet thermometer and a flowmeter are installed on the inlet flue, and an outlet thermometer is installed on the outlet flue. An intermediate thermometer and a pressure gauge are installed on the drying tower. The controller is provided with a calculation module, and the calculation module can calculate the movement time t₁ of the flue gas in the constant rate evaporation stage, the movement time t₂ of the flue gas in the falling rate evaporation stage and the total flue gas residence time tₐₗₗ, according to the data fed back by the inlet thermometer, the outlet thermometer, the intermediate thermometer, the flowmeter and the pressure gauge. The controller controls the wastewater adjusting valve and the flue gas adjusting valve according to the total flue gas residence time tₐₗₗ to adjust the wastewater flow rate and the flue gas flow rate.

Specifically, the upper part of the drying tower is a hollow cylinder, the bottom of the drying tower is a hollow cone, and the inlet flue and the outlet flue are installed on the top and bottom of the hollow cylinder, respectively. The rotary atomizer is used for atomizing the wastewater, and can be installed in the center of the top of the drying tower. The wastewater adjusting valve is used for adjusting the flow rate of the wastewater. The flue gas adjusting valve is used for adjusting the flue gas flow rate. The inlet thermometer is used for monitoring the inlet flue gas temperature T₁ in real time, and the flowmeter is used for monitoring the volume flow V of the flue gas in real time, which is converted to obtain the molar flow rate n. The inlet thermometer and the flowmeter can be installed at the depth position of ½ diameter in the inlet flue, and can be installed on the interval of 0.8 m-1.2 m. The outlet thermometer is used for monitoring the outlet flue gas temperature T₂ in real time, and can be installed at the depth position of ½ diameter in the outlet flue. The intermediate thermometer is used for monitoring the critical temperature T_{c} of flue gas between the constant rate evaporation stage and the falling rate evaporation stage in real time. It can be installed at the depth position of ⅛ diameter in the hollow cylinder. The pressure gauge is used for monitoring the flue gas pressure P in real time, and can be installed at the ½ height position of the hollow cylinder and the depth position of ⅛ diameter in the hollow cylinder.

Further, according to the solid content x of the wastewater, the intermediate thermometer is set as follows.

When the solid content x of the wastewater is x≤10%, the intermediate thermometer is installed at a position 4.5 m-5.4 m away from the top of the drying tower.

When the solid content x of the wastewater is 10%<x≤20%, the intermediate thermometer is installed at a position 3.5 m-4.4 m away from the top of the drying tower.

When the solid content x of the wastewater is 20%<x≤30%, the intermediate thermometer is installed at a position 2.5 m-3.4 m away from the top of the drying tower.

The present application provides a monitoring method and a monitoring system for wastewater zero discharge. By monitoring key parameters of the system, a data basis is provided for kinetics models. The established models take full consideration of the constant and falling rate evaporation characteristics. The linear models of the relationships between the flue gas movement time and distance are established, improving the accuracy of the total residence time. In addition, intelligent control methods are formulated for different wastewater types according to the total residence time. Thus, the operation stability of the drying tower is remarkably improved, and the effect for drying wastewater is ensured.

### BRIEF DESCRIPTION OF THE DRAWINGS

In order to explain the embodiments of the present application or the technical solutions in the prior art more clearly, the drawings needed to be used in the description of the embodiments or the prior art will be briefly introduced below. Obviously, the drawings in the following description are only some embodiments of the present application. For those of ordinary skill in the art, other drawings can be obtained based on these drawings without creative labor.

FIG. 1 is a schematic diagram of structure of a drying tower according to an embodiment of the present application.

Reference signs are denoted as follows:

1: drying tower; 2: rotary atomizer; 3: inlet flue; 4: outlet flue; 5: wastewater pipeline; 6: outlet thermometer; 7: flue gas adjusting valve; 8: inlet thermometer; 9: intermediate thermometer; 10: pressure gauge; 11: flowmeter; 12: wastewater adjusting valve.

### DETAILED DESCRIPTION OF THE INVENTION

It should be noted that the following detailed description is exemplary and is intended to provide a further description of the present application. Unless otherwise specified, all technical and scientific terms used herein have the same meaning as commonly understood by one of ordinary skill in the art to which the present application belongs.

It should be noted that the terminology used herein is for the purpose of describing particular embodiments only and is not intended to limit the exemplary embodiments according to the present application. As used herein, the singular forms include the plural forms as well, unless the context clearly indicates otherwise, and it is also to be understood that the terms “comprising” and/or “including” when used in this specification, specify the presence of features, steps, operations, devices, components, and/or combinations thereof.

The technical scheme of the present application will be clearly and completely described below with reference to the embodiments. Obviously, the described embodiments are a part of the embodiments of the present application rather than all the embodiments. All other embodiments obtained by a person of ordinary skill in the art based on the embodiments of the present application without creative efforts shall fall within the protection scope of the present application.

### Embodiment 1

The present application provides a monitoring method for wastewater zero discharge, including the following steps.

S1: Feed atomized wastewater into a drying tower, extract high temperature flue gas into the drying tower to evaporate the atomized wastewater droplets, and monitor an outlet flue gas temperature T₂ of the drying tower in real time.

S2: Obtain a movement time t₁ of the flue gas in a constant rate evaporation stage and a movement time t₂ in a falling rate evaporation stage, respectively, and obtain a total residence time tₐₗₗ of the flue gas according to the movement time t₁ and the movement time t₂, tₐₗₗ=t₁+t₂.

S3: Adjust wastewater flow rate and flue gas flow rate according to the total residence time tₐₗₗ of the flue gas, and maintain the outlet flue gas temperature T₂ of the drying tower within the range of 428 K to 448 K.

Specifically, a rotary atomizer is adopted to atomize the wastewater, the rotating speed of the atomizer is controlled between 12000 r/min-18000 r/min, and the diameters of the atomized wastewater droplets are between 10 μm-60 μm.

In the evaporation process, relevant parameters such as inlet flue gas temperature T₁, outlet flue gas temperature T₂, critical temperature T_{c} of flue gas between the constant rate evaporation stage and the falling rate evaporation stage, flue gas pressure P, and flue gas volume flow V, etc., are monitored in real time. Cross-sectional area of the drying tower is calculated according to the tower diameter, and the molar flow rate n is calculated according to the flue gas volume flow V.

a₁ and b₁ are obtained by the following formulas:

$${a}_{1} = \frac{{T}_{c} - {T}_{1}}{{L}_{1}} ,$$

$${b}_{1} = {T}_{1} ,$$

where T_{c} is the critical temperature of the flue gas between the constant rate evaporation stage and the falling rate evaporation stage, T₁ is the inlet flue gas temperature, and L₁ is the vertical flow distance of the flue gas in the constant rate evaporation stage.

The movement time t₁ of the flue gas during the constant rate evaporation stage is obtained by the following formula:

$${t}_{1} = \frac{PS}{{nRa}_{1}} Ln ( \frac{{a}_{1}}{{b}_{1}} {L}_{1} + 1 ) ,$$

where t₁ is the movement time of the flue gas in the constant rate evaporation stage; P is the pressure of the flue gas; S is the cross-sectional area of the drying tower; n is the molar flow rate; R is the gas constant; a₁ and b₁ are model parameters; and L is the vertical flow distance of the flue gas in the constant rate evaporation stage.

a₂ and b₂ are obtained by the following formulas:

$${a}_{2} = \frac{{T}_{2} - {T}_{c}}{h - {L}_{1}} ,$$

$${b}_{2} = {T}_{c} ,$$

where T₂ is the outlet flue gas temperature; T_{c} is the critical temperature of the flue gas between the constant rate evaporation stage and the falling rate evaporation stage; h is the height of the drying tower; and L is the vertical flow distance of the flue gas in the constant rate evaporation stage.

The movement time t₂ of the flue gas in the falling rate evaporation stage is obtained by the following formula:

$${t}_{2} = \frac{PS}{{nRa}_{2}} Ln ( \frac{{a}_{2}}{{b}_{2}} {L}_{2} + 1 ) ,$$

where t₂ is the movement time of the flue gas in the falling rate evaporation stage; P is the pressure of the flue gas; S is the cross-sectional area of the drying tower; n is the molar flow rate; R is the gas constant; a₂ and b₂ are model parameters; and L₂ is the vertical flow distance of the flue gas in the falling rate evaporation stage (L₂ is obtained from L₂=h−L₁).

After the movement time t₁ of the flue gas in the constant rate evaporation stage and the movement time t₂ of the flue gas in the falling rate evaporation stage are obtained, the total residence time tₐₗₗ of the flue gas is obtained from tₐₗₗ=t₁+t₂.

The control range for the total residence time tₐₗₗ of the flue gas is determined as follows.

When the solid content x of the wastewater is x≤10%, the control range for the total residence time tₐₗₗ is [30 s, 35 s).

When the solid content x of the wastewater is 10%<x≤20%, the control range for the total residence time tₐₗₗ is [35 s, 40 s).

When the solid content x of the wastewater is 20%<x≤30%, the control range for the total residence time tₐₗₗ is [40 s, 45 s].

According to the obtained total residence time tₐₗₗ and its control range, the wastewater flow rate and the flue gas flow rate are adjusted as follows.

When the total residence time tₐₗₗ of the flue gas is within the control range, and the outlet flue gas temperature 72 of the drying tower is maintained at 428 K-448 K, keep the wastewater flow rate and the flue gas flow rate unchanged.

When the total residence time tₐₗₗ of the flue gas is below the lower limit of the control range, reduce the wastewater flow rate and flue gas flow rate until the total residence time tₐₗₗ is within the control range, and the outlet flue gas temperature of the drying tower is maintained at 428 K-448 K. During the adjusting process, the decreasing rate of the flue gas flow rate should not exceed that of the wastewater flow rate.

When the total residence time tₐₗₗ of the flue gas is higher than the upper limit of the control range, increase the wastewater flow rate and the flue gas flow rate until the total residence time tₐₗₗ of the flue gas is within the control range, and the outlet flue gas temperature T₂ of the drying tower is maintained at 428 K-448 K. During the adjusting process, the increasing rate of the wastewater flow rate should not exceed that of the flue gas flow rate.

### Embodiment 2

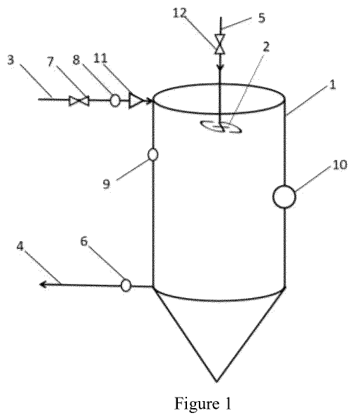

As shown in FIG. 1, a monitoring system for wastewater zero discharge according to the embodiment is used for implementing the monitoring method supplied in embodiment 1. The monitoring system for wastewater zero discharge includes a drying tower 1 and a controller (not shown in FIG. 1). A rotary atomizer 2 is installed on the top of the drying tower 1 and is connected with a wastewater pipeline 5, and a wastewater adjusting valve 12 is installed on the wastewater pipeline 5. An inlet flue 3 and an outlet flue 4 are installed on the top and bottom of the drying tower 1, respectively. A flue gas adjusting valve 7, an inlet thermometer 8 and a flowmeter 11 are installed on the inlet flue 3, and an outlet thermometer 6 is installed on the outlet flue 4. An intermediate thermometer 9 and a pressure gauge 10 are installed on the drying tower 1. The controller is provided with a calculation module, and the calculation module can calculate the movement time t₁ of the flue gas in the constant rate evaporation stage, the movement time t₂ of the flue gas in the falling rate evaporation stage and the total residence time tₐₗₗ of the flue gas, according to the data fed back by the inlet thermometer 8, the outlet thermometer 6, the intermediate thermometer 9, the flowmeter 11 and the pressure gauge 10. The controller controls the wastewater adjusting valve 12 and the flue gas adjusting valve 7 according to the total residence time tₐₗₗ of the flue gas to adjust the wastewater flow rate and the flue gas flow rate.

Specifically, the upper part of the drying tower 1 is a hollow cylinder, and the bottom of the drying tower 1 is a hollow cone. The rotary atomizer 2 is used for atomizing the wastewater, and can be installed in the center of the top of the drying tower 1. The wastewater adjusting valve 12 is used for adjusting the flow rate of the wastewater. The flue gas adjusting valve 7 is used for adjusting the flue gas flow rate. The inlet thermometer 8 is used for monitoring the inlet flue gas temperature T₁ in real time, and the flowmeter 11 is used for monitoring the flue gas volume flow rate V, which is converted to obtain the molar flow rate n. The inlet thermometer 8 and the flowmeter 11 can be installed at the depth position of ½ diameter in the inlet flue 3, and can be arranged on the interval of 0.8 m-1.2 m. The outlet thermometer 6 is used for monitoring the outlet flue gas temperature T₂ in real time, and can be installed at the depth position of ½ diameter in the outlet flue 4. The intermediate thermometer 9 is used for monitoring the critical temperature T_{c} of the flue gas between the constant rate evaporation stage and the falling rate evaporation stage in real time. It can be installed at the depth position of ⅛ diameter in the hollow cylinder. The pressure gauge 10 is used for monitoring the flue gas pressure P in real time, and can be installed at the ½ height position of the hollow cylinder and the depth position of the ⅛ diameter in the hollow cylinder.

According to the solid content x of the wastewater, the intermediate thermometer 9 is set as follows.

When the solid content x of the wastewater is x≤10%, the intermediate thermometer 9 is installed at a position 4.5 m-5.4 m away from the top of the drying tower 1.

When the solid content x of the wastewater is 10%<x≤20%, the intermediate thermometer 9 is installed at a position 3.5 m-4.4 m away from the top of the drying tower 1.

When the solid content x of the wastewater is 20%<x≤30%, the intermediate thermometer 9 is installed at a position 2.5 m-3.4 m away from the top of the drying tower 1.

### Embodiment 3

The monitoring system for wastewater zero discharge according to embodiment 2 is used to evaporate the wastewater. The parameters are as follows: the solid content x of the wastewater is 5%, the inlet flue gas temperature T₁ is 633 K, the outlet flue gas temperature T₂ is 448 K, the diameter of the drying tower is 8.5 m, the height h of the drying tower is 15 m, the intermediate thermometer is installed at a position 5 m away from the top of the drying tower (i.e., L₁ is 5 m), and the design value of the flue gas flow rate is 58100 Nm³/h.

In the constant rate evaporation stage,
the flue gas temperature is: T=a₁L+b₁=−34.6L+633, and
the movement time of the flue gas is:

$${t}_{1} = \frac{PS}{{nRa}_{1}} Ln ( \frac{{a}_{1}}{{b}_{1}} {L}_{1} + 1 ) \approx 8.9 s .$$

In the falling rate evaporation stage,
the flue gas temperature is: T=a₂L+b₂=−1.2L+460, and
the movement time of the flue gas is:

$${t}_{2} = \frac{PS}{{nRa}_{2}} Ln ( \frac{{a}_{2}}{{b}_{2}} {L}_{2} + 1 ) \approx 21.2 s .$$

The total residence time of the flue gas is: tₐₗₗ=t₁+t₂˜8.9+21.2˜30.1 s.

According to the parameters mentioned above, actual operation is carried out, and the actual total residence time is measured to be 33.2 s. It can be seen that the total residence time tₐₗₗ calculated according to the embodiment is very close to the measured value. Therefore, the total residence time of the flue gas during operation of the drying tower can be accurately obtained through the calculation method supplied in the embodiment.

### Embodiment 4

The monitoring system for wastewater zero discharge according to embodiment 2 is used to evaporate the wastewater. The parameters are as follows: the solid content x of the wastewater is 17%, the inlet flue gas temperature T₁ is 611 K, the outlet flue gas temperature T₂ is 438 K, the diameter of the drying tower is 7.5 m, the height h of the drying tower is 11.5 m, the intermediate thermometer is installed at a position 4 m away from the top of the drying tower (i.e., L₁ is 4 m), and the design value of the flue gas flow rate is 30700 Nm³/h.

In the constant rate evaporation stage,
the flue gas temperature is: T=a₁L+b₁=−41.3L+611, and
the movement time of the flue gas is:

$${t}_{1} = \frac{PS}{{nRa}_{1}} Ln ( \frac{{a}_{1}}{{b}_{1}} {L}_{1} + 1 ) \approx 10.9 s .$$

In the falling rate evaporation stage,
the flue gas temperature is: T=a₂L+b₂=−1.1L+446, and
the movement time of the flue gas is:

$${t}_{2} = \frac{PS}{{nRa}_{2}} Ln ( \frac{{a}_{2}}{{b}_{2}} {L}_{2} + 1 ) \approx 24.2 s .$$

The total residence time of the flue gas is: tₐₗₗ=t₁+t₂˜10.9+24.2≈35.1 s.

According to the parameters mentioned above, actual operation is carried out, and the actual total residence time is measured to be 37.8 s. It can be seen that the total residence time tₐₗₗ calculated according to the embodiment is very close to the measured value. Therefore, the total residence time of the flue gas during operation of the drying tower can be accurately obtained through the calculation method supplied in the embodiment.

### Embodiment 5

The monitoring system for wastewater zero discharge according to embodiment 2 is used to evaporate the wastewater. The parameters are as follows: the solid content x of the wastewater is 25%, the inlet flue gas temperature T₁ is 645 K, the outlet flue gas temperature T₂ is 428 K, the diameter of the drying tower is 7 m, the height h of the drying tower is 14 m, the intermediate thermometer is installed at a position 3 m away from the top of the drying tower (i.e., L₁ is 3 m), and the design value of the flue gas flow rate is 29600 Nm³/h.

In the constant rate evaporation stage,
the flue gas temperature is: T=a₁L+b₁=−70L+645, and
the movement time of the flue gas is:

$${t}_{1} = \frac{PS}{{nRa}_{1}} Ln ( \frac{{a}_{1}}{{b}_{1}} {L}_{1} + 1 ) \approx 7.3 s .$$

In the falling rate evaporation stage,
the flue gas temperature is: T=a₂L+b₂=−0.6L+435, and
the movement time of the flue gas is:

$${t}_{2} = \frac{P S}{n R {a}_{2}} Ln ( \frac{{a}_{2}}{{b}_{2}} {L}_{2} + 1 ) \approx 32.9 s .$$

The total residence time of the flue gas is: tₐₗₗ=t₁+t₂≈7.3+32.9≈40.2 s.

According to the parameters mentioned above, actual operation is carried out, and the actual total residence time is measured to be 42.8 s. It can be seen that the total residence time tₐₗₗ calculated according to the embodiment is very close to the measured value. Therefore, the total residence time of the flue gas during operation of the drying tower can be accurately obtained through the calculation method supplied in the embodiment.

### Embodiment 6

According to the method supplied by embodiment 3, the total residence time tₐₗₗ of the flue gas is calculated to be 30.1 s. While the actual total residence time tₐₗₗ is measured to be 33.2 s in embodiment 3. In this embodiment, the actual flue gas flow rate is adjusted from 58100 Nm³/h to 63625 Nm³/h, and thus the actual residence time of flue gas is adjusted from 33.2 s to 30.1 s. The other parameters are the same as those in embodiment 3.

The actual operation is carried out according to the adjusted flue gas flow rate. In the actual operation process, the total residence time tₐₗₗ of the flue gas is calculated by the method according to embodiment 3, and the wastewater flow rate and flue gas flow rate of the drying tower are adjusted as follows.

When 30 s≤tₐₗₗ<35 s and the outlet flue gas temperature T₂ of the drying tower is maintained at 428 K-448 K, keep the wastewater flow rate and the flue gas flow rate unchanged.

When tₐₗₗ<30 s, reduce the wastewater flow rate and the flue gas flow rate until 30 s≤tₐₗₗ<35 s, and the outlet flue gas temperature T₂ of the drying tower is maintained at 428 K-448 K.

When tₐₗₗ≥35 s, increase the wastewater flow rate and the flue gas flow rate until 30 s≤tₐₗₗ<35 s, and the outlet flue gas temperature T₂ of the drying tower is maintained at 428 K-448 K.

Five ash samples are collected from the outlet flue of the drying tower during operation, the moisture contents of the ash samples are measured respectively, and the results are shown in table 1. It is shown that the moisture contents of the five ash samples are within the range of 1%-2%, and the average moisture content is 1.39%, which satisfy the requirement of industry standard (the moisture content of the ash at the outlet flue of the drying tower should not exceed 2%).

### Embodiment 7

According to the method supplied by embodiment 4, the total residence time tₐₗₗ of the flue gas is calculated to be 35.1 s. While the actual total residence time tₐₗₗ is measured to be 37.8 s in embodiment 4. In this embodiment, the actual flue gas flow rate is adjusted from 30700 Nm³/h to 32760 Nm³/h, and thus the actual residence time of flue gas is adjusted from 37.8 s to 35.1 s. The other parameters are the same as those in embodiment 4.

The actual operation is carried out according to the adjusted flue gas flow rate. In the actual operation process, the total residence time tₐₗₗ of the flue gas is calculated by the method according to embodiment 4, and the wastewater flow rate and flue gas flow rate of the drying tower are adjusted as follows.

When 35 s≤tₐₗₗ<40 s and the outlet flue gas temperature T₂ of the drying tower is maintained at 428 K-448 K, keep the wastewater flow rate and the flue gas flow rate unchanged.

When tₐₗₗ<35 s, reduce the wastewater flow rate and the flue gas flow rate until 35 s≤tₐₗₗ<40 s, and the outlet flue gas temperature T₂ of the drying tower is maintained at 428 K-448 K.

When tₐₗₗ>40 s, increase the wastewater flow rate and the flue gas flow rate until 35 s≤tₐₗₗ<40 s, and the outlet flue gas temperature T₂ of the drying tower is maintained at 428 K-448 K.

Five ash samples are collected from the outlet flue of the drying tower during operation, the moisture contents of the ash samples are measured respectively. The results show that the moisture contents of the five ash samples are within the range of 1%-2%, and the average moisture content is 1.15%, which satisfy the requirement of industry standard.

### Embodiment 8

According to the method supplied by embodiment 5, the total residence time tₐₗₗ of the flue gas is calculated to be 40.2 s. While the actual total residence time tₐₗₗ is measured to be 42.8 s in embodiment 5. In this embodiment, the actual flue gas flow rate is adjusted from 29600 Nm³/h to 31254 Nm³/h, and thus the actual residence time of flue gas is adjusted from 42.8 s to 40.2 s. The other parameters are the same as those in embodiment 5.

The actual operation is carried out according to the adjusted flue gas flow rate. In the actual operation process, the total residence time tₐₗₗ of the flue gas is calculated by the method according to embodiment 5, and the wastewater flow rate and flue gas flow rate of the drying tower are adjusted as follows.

When 40 s≤tₐₗₗ<45 s and the outlet flue gas temperature T₂ of the drying tower is maintained at 428 K-448 K, keep the wastewater flow rate and the flue gas flow rate unchanged.

When tₐₗₗ<40 s, reduce the wastewater flow rate and the flue gas flow rate until 40 s≤tₐₗₗ≤45 s, and the outlet flue gas temperature T₂ of the drying tower is maintained at 428 K-448 K.

When tₐₗₗ>45 s, increase the wastewater flow rate and the flue gas flow rate until 40 s≤tₐₗₗ≤45 s, and the outlet flue gas temperature T₂ of the drying tower is maintained at 428 K-448 K.

Five ash samples are collected from the outlet flue of the drying tower during operation, the moisture contents of the ash samples are measured respectively. The results show that the moisture contents of the five ash samples are within the range of 1%-2%, and the average moisture content is 1.52%, which satisfy the requirement of industry standard.

### Comparative Example 1

In this comparative example, the total residence time tₐₗₗ of the flue gas is obtained by adopting an average flow velocity. The parameters of the system are the same as those in embodiment 3. The average flow velocity of the flue gas is calculated as follows.

The average temperature of the flue gas is:

$$\overline{T} = \frac{{T}_{1} + {T}_{2}}{2} = 540.5 K .$$

The average flow velocity is:

$$\overline{v} = \frac{n R}{P S} \overline{T} \approx 0.562 m / s .$$

The total flue gas residence time is:

$${t}_{a l l} = \frac{h}{\overline{v}} \approx 26.7 s .$$

According to the parameters mentioned above, actual operation is carried out, and the actual total residence time is measured to be 33.2 s. It can be seen that the total residence time tₐₗₗ calculated according to the comparative example is greatly different from the measured value. Therefore, the total residence time of the flue gas during operation of the drying tower cannot be accurately obtained through the calculation method supplied in the comparative example.

According to the total flue gas residence time tₐₗₗ˜26.7 s obtained from the above calculation, the actual flue gas flow rate is adjusted from 58100 Nm³/h to 71536 Nm³/h, and thus the actual residence time of flue gas is adjusted from 33.2 s to 26.7 s. Actual operation is carried out in accordance with the adjusted flue gas flow rate, and moisture content of the ash at the outlet flue is measured. The result shows that the moisture content of the ash is 2.81%, which cannot meet the requirement of industry standard (the moisture content of the ash at the outlet flue of the drying tower should not exceed 2%).

### Comparative Example 2

In this comparative example, the total residence time tₐₗₗ of the flue gas is obtained by adopting an average flow velocity. The parameters of the system are the same as those in embodiment 4. The average flow velocity of the flue gas is calculated as follows.

The average temperature of the flue gas is:

$$\overline{T} = \frac{{T}_{1} + {T}_{2}}{2} = 524.5 K .$$

The average flow velocity is:

$$\overline{v} = \frac{n R}{P S} \overline{T} \approx 0.3 \; 68 m / s .$$

The total flue gas residence time is:

$${t}_{a l l} = \frac{h}{\overline{v}} \approx 31.2 s .$$

According to the parameters mentioned above, actual operation is carried out, and the actual total residence time is measured to be 37.8 s. It can be seen that the total residence time tₐₗₗ calculated according to the comparative example is greatly different from the measured value. Therefore, the total residence time of the flue gas during operation of the drying tower cannot be accurately obtained through the calculation method supplied in the comparative example.

According to the total flue gas residence time tₐₗₗ≈31.2 s obtained from the above calculation, the actual flue gas flow rate is adjusted from 30700 Nm³/h to 36643 Nm³/h, and thus the actual residence time of flue gas is adjusted from 37.8 s to 31.2 s. Actual operation is carried out in accordance with the adjusted flue gas flow rate, and moisture content of the ash at the outlet flue is measured. The result shows that the moisture content of the ash is 3.40%, which cannot meet the requirement of industry standard.

### Comparative Example 3

In this comparative example, the total residence time of the flue gas is obtained by adopting an average flow velocity. The parameters of the system are the same as those in embodiment 5. The average flow velocity of the flue gas is calculated as follows.

The average temperature of the flue gas is:

$$\overline{T} = \frac{{T}_{1} + {T}_{2}}{2} = 536.5 K .$$

The average flow velocity is:

$$\overline{v} = \frac{n R}{P S} \overline{T} \approx 0.416 m / s .$$

The total flue gas residence time is:

$${t}_{a l l} = \frac{h}{\overline{v}} \approx 33.6 s .$$

According to the parameters mentioned above, actual operation is carried out, and the actual total residence time is measured to be 42.8 s. It can be seen that the total residence time tₐₗₗ calculated according to the comparative example is greatly different from the measured value. Therefore, the total residence time of the flue gas during operation of the drying tower cannot be accurately obtained through the calculation method supplied in the comparative example.

According to the total flue gas residence time tₐₗₗ≈33.6 s obtained from the above calculation, the actual flue gas flow rate is adjusted from 29600 Nm³/h to 37420 Nm³/h, and thus the actual residence time of flue gas is adjusted from 42.8 s to 33.6 s. Actual operation is carried out in accordance with the adjusted flue gas flow rate, and moisture content of the ash at the outlet flue is measured. The result shows that the moisture content of the ash is 3.15%, which cannot meet the requirement of industry standard.

### Comparative Example 4

Except that the flow rates of wastewater and flue gas are not adjusted during the operation process, the remaining conditions are the same as those in embodiment 6.

Ash samples are collected and the moisture content is measured, and the results are shown in Table 1.

### Comparative Example 5

Except that the flow rates of wastewater and flue gas are adjusted as follows during the operation process, the remaining conditions are the same as those in Embodiment 6.

In this comparative example, the outlet flue gas temperature T₂ of the drying tower is monitored during operation. According to the outlet flue gas temperature T₂, the flow rates of wastewater and flue gas are adjusted as follows.

When 150° C.≤T₂≤160° C., keep the flow rates of wastewater and flue gas unchanged.

When T₂<150° C., reduce the wastewater flow rate and/or increase the flue gas flow rate, until 150° C.≤T₂≤160° C.

When T₂>160° C., increase the wastewater flow rate and/or reduce the flue gas flow rate until 150° C.≤T₂≤160° C.

Ash samples are collected, the moisture contents are measured, and the results are shown in Table 1.

TABLE 1
Detection results for moisture content of ash samples at the outlet flue

| | Moisture content of ash (%) | | | | | |
|---|---|---|---|---|---|---|
| Method | Day 10 | Day 20 | Day 30 | Day 40 | Day 50 | Operation effect |
| Embodiment 6 | 1.09 | 1.38 | 1.50 | 1.29 | 1.68 | The wastewater zero discharge |
| | | | | | | system works well, and the |
| | | | | | | moisture contents of ashes are |
| | | | | | | stably maintained at 1%-2%. |
| | | | | | | There are no failures during |
| | | | | | | operation, such as wet ash, |
| | | | | | | blockages, ash agglomeration and |
| | | | | | | hardening, etc. |
| Comparative | 1.12 | 3.84 | 4.72 | 1.73 | 5.09 | Drying effect of the wastewater is |
| Example 4 | | | | | | unstable, and the moisture |
| | | | | | | contents of ashes fluctuate greatly. |
| | | | | | | Problems such as wet ash, |
| | | | | | | blockages, have been detected for |
| | | | | | | multiple times. Parts of the ash are |
| | | | | | | agglomerated and hardened. |
| | | | | | | The wastewater zero discharge |
| | | | | | | system does not work well. |
| Comparative | 1.38 | 1.70 | 2.37 | 2.60 | 2.78 | The moisture contents of ashes |
| Example 5 | | | | | | fluctuate, and the effect of |
| | | | | | | wastewater drying is unstable. |
| | | | | | | Problems such as wet ash, |
| | | | | | | blockages, are detected during |
| | | | | | | operation. Parts of ash are |
| | | | | | | agglomerated and hardened. |

The results show as follows.

1. When it is operated by the method according to Embodiment 6, the wastewater zero discharge system works well. The moisture contents of ashes are stably maintained at 1%-2%, which satisfies the requirement of industry standard and the recycling of fly ash. Various problems induced by instability of high temperature flue gas can be well overcome. The operation stability of the drying tower is remarkably improved, and the effect for drying wastewater is ensured.

2. When it is operated by the method according to Comparative Example 4, the wastewater zero discharge system does not work well without adjustment of the flue gas flow rate and the wastewater flow rate. Various problems induced by instability of high temperature flue gas cannot be well overcome. The moisture contents of ashes at the outlet flue of the drying tower fluctuate greatly. Problems such as wet ash, blockages, have been detected for multiple times. The stability of the system operation and the recycling of fly ash are seriously affected.

3. When it is operated by the method according to Comparative Example 5, the flow rates of wastewater and flue gas are adjusted according to the outlet flue gas temperature of the drying tower. The effect of wastewater drying is unstable. Problems such as wet ash, blockages, are detected during operation. Parts of ash are agglomerated and hardened. The stability of the system operation and the recycling of fly ash are adversely affected.

Finally, it should be noted that the above embodiments are only used to illustrate the technical solutions of the present application and are not to limit them. Although the present application is described in detail with reference to the foregoing embodiments, a person of ordinary skill in the art should understand that the technical solutions described in the foregoing embodiments may still be modified, or some or all of the technical features may be equivalently replaced. These modifications or replacements do not make the essence of the corresponding technical solutions depart from the scope of the technical solutions of the embodiments of the present application.

1. A monitoring method for wastewater zero discharge comprising steps of:
S1: feeding atomized wastewater into a drying tower, extracting high temperature flue gas into the drying tower to evaporate the atomized wastewater droplets, and monitoring an outlet flue gas temperature T2 of the drying tower in real time;
S2: obtaining a movement time t1 of the flue gas in a constant rate evaporation stage and a movement time t2 of the flue gas in a falling rate evaporation stage, respectively, and obtaining a total residence time tall of the flue gas according to the movement time t1 and the movement time t2, tall=t1+t2; and
S3: adjusting flow rates of the wastewater and the flue gas according to the total residence time tall of the flue gas, and maintaining the outlet flue gas temperature T2 of the drying tower within the range of 428 K to 448 K.

2. The monitoring method for wastewater zero discharge according to claim 1, wherein the movement time t₁ of the flue gas in the constant rate evaporation stage is obtained by the following formula:
$${t}_{1} = \frac{P S}{n R {a}_{1}} Ln ( \frac{{a}_{1}}{{b}_{1}} {L}_{1} + 1 ) ,$$
wherein t₁ is the movement time of the flue gas in the constant rate evaporation stage; P is the pressure of the flue gas; S is the cross-sectional area of the drying tower; n is a molar flow rate; R is the gas constant; a₁ and b₁ are model parameters; and L₁ is the vertical flow distance of the flue gas in the constant rate evaporation stage.

3. The monitoring method for wastewater zero discharge according to claim 2, wherein a₁ and b₁ are obtained by the following formulas:
$${a}_{1} = \frac{{T}_{c} - {T}_{1}}{{L}_{1}} ,$$
$${b}_{1} = {T}_{1} ,$$
wherein T_{c} is the critical temperature of the flue gas between the constant rate evaporation stage and the falling rate evaporation stage, and T₁ is an inlet flue gas temperature.

4. The monitoring method for wastewater zero discharge according to claim 1, wherein the movement time t₂ of the flue gas in the falling rate evaporation stage is obtained by the following formula:
$${t}_{2} = \frac{P S}{n R {a}_{2}} Ln ( \frac{{a}_{2}}{{b}_{2}} {L}_{2} + 1 ) ,$$
wherein t₂ is the movement time of the flue gas in the falling rate evaporation stage; P is the pressure of the flue gas; S is the cross-sectional area of the drying tower; n is a molar flow rate; R is the gas constant; a₂ and b₂ are model parameters; and L₂ is the vertical flow distance of the flue gas in the falling rate evaporation stage.

5. The monitoring method for wastewater zero discharge according to claim 4, wherein a₂ and b₂ are obtained by the following formulas:
$${a}_{2} = \frac{{T}_{2} - {T}_{c}}{h - {L}_{1}} ,$$
$${b}_{2} = {T}_{c} ,$$
wherein T₂ is an outlet flue gas temperature; T_{c} is the critical temperature of the flue gas between the constant rate evaporation stage and the falling rate evaporation stage; h is the height of the drying tower; and L₁ is the vertical flow distance of the flue gas in the constant rate evaporation stage.

6. The monitoring method for wastewater zero discharge according to claim 1, wherein, according to the solid content x of the wastewater, control ranges for the total residence time tₐₗₗ are determined to be:
$$30 s ⩽ {t}_{all} < 35 s , when x ⩽ 10 \% ;$$
$$35 s ⩽ {t}_{all} < 40 s , when 10 \% < x ⩽ 20 \% ; and$$
$$40 s ⩽ {t}_{all} < 45 s , when 20 \% < x ⩽ 30 \% .$$

7. The monitoring method for wastewater zero discharge according to claim 6, wherein the wastewater flow rate and the flue gas flow rate are adjusted in a manner that:
when the total residence time tₐₗₗ of the flue gas is within the control range and the outlet flue gas temperature T₂ of the drying tower is maintained at 428 K-448 K, the wastewater flow rate and the flue gas flow rate are kept unchanged;
when the total residence time tₐₗₗ of the flue gas is below the lower limit of the control range, the wastewater flow rate and flue gas flow rate are reduced until the total residence time tₐₗₗ is within the control range, the outlet flue gas temperature T₂ of the drying tower is maintained at 428 K-448 K, and the decreasing rate of the gas flow rate does not exceed that of the wastewater flow rate during the adjusting process; and
when the total residence time tₐₗₗ of the flue gas is higher than the upper limit of the control range, the wastewater flow rate and the flue gas flow rate are increased until the total residence time tₐₗₗ of the flue gas is within the control range, the outlet flue gas temperature T: of the drying tower is maintained at 428 K-448 K, and the increasing rate of the wastewater flow rate does not exceed that of the gas flow rate during the adjusting process.

8. The monitoring method for wastewater zero discharge according to claim 1, wherein a rotary atomizer is adopted to atomize the wastewater, and the diameters of the atomized wastewater droplets are between 10 μm-60 μm.

9. A monitoring system for wastewater zero discharge for implementing the monitoring method according to claim 1, comprising a drying tower and a controller, wherein a rotary atomizer is installed on the top of the drying tower and is connected with a wastewater pipeline, a wastewater adjusting valve is installed on the wastewater pipeline, an inlet flue and an outlet flue are respectively installed on the top and bottom of the drying tower, a flue gas adjusting valve, an inlet thermometer and a flowmeter are installed on the inlet flue, an outlet thermometer is installed on the outlet flue, an intermediate thermometer and a pressure gauge are installed on the drying tower, the controller is provided with a calculation module, the calculation module calculates a movement time t₁ of flue gas in a constant rate evaporation stage, a movement time t₂ of the flue gas in a falling rate evaporation stage, and a total flue gas residence time tₐₗₗ, according to data fed back by the inlet thermometer, the outlet thermometer, the intermediate thermometer, the flowmeter, and the pressure gauge, and the controller controls the wastewater adjusting valve and the flue gas adjusting valve according to the total flue gas residence time tan to adjust the wastewater flow rate and the flue gas flow rate.

10. The monitoring system for wastewater zero discharge according to claim 9, wherein, according to the solid content x of wastewater, the intermediate thermometer is set in a manner that:
when x≤10%, the intermediate thermometer is installed at a position 4.5 m-5.4 m away from the top of the drying tower;
when 10%<x≤20%, the intermediate thermometer is installed at a position 3.5 m-4.4 m away from the top of the drying tower, and
when 20%<x≤30%, the intermediate thermometer is installed at a position 2.5 m-3.4 m away from the top of the drying tower.
